(19) United States
(12) Patent Application Publication
(10) Pub. No.: US 2024/0190494 A1
(43) Pub. Date: Jun. 13, 2024

(54) Electric Hand Truck

(71) Applicants: Boonsieng Benjauthrit, La Canada, CA (US); Sorapod B. Benjauthrit, La Canada, CA (US); Vatcharee Y. Benjauthrit, La Canada, CA (US)

(72) Inventors: Boonsieng Benjauthrit, La Canada, CA (US); Sorapod B. Benjauthrit, La Canada, CA (US); Vatcharee Y. Benjauthrit, La Canada, CA (US)

(21) Appl. No.: 18/067,697

(22) Filed: Dec. 16, 2022

Related U.S. Application Data
(60) Provisional application No. 63/290,199, filed on Dec. 16, 2021.

(51) Int. Cl. B62B 5/00; B62B 1/12; G01G 19/12

(52) U.S. Cl. CPC B62B 5/0076; B62B 1/12; B62B 5/0053; G01G 19/12

(57) ABSTRACT

A hand truck comprising: a frame with an axle, at least two wheels, and a small handle; a nose plate, a nose plate extension, and an arbor; and a handle with a handle support bar, two casters.

### BACKGROUND

The present invention, in some embodiments thereof, relates to hand trucks for carrying and lifting objects.

For convenience and to save energy, hand trucks are mechanical devices that have been effectively employed to move objects from one location to another. Most hand trucks have two wheels, but a substantial number of hand trucks have four or more wheels. Many modern hand trucks incorporate two more wheels on existing standard two-wheel hand trucks so if four wheels are needed, they can be ‘unfolded’ to accommodate the needs, which is also known as a dolly. This is rather convenient, especially for household applications where hand trucks are needed but only sporadically used.

The following references show different solutions in the general art:

U.S. PATENT DOCUMENTS

| 1,165,714 A | December 1915 | Ruckes |
|---|---|---|
| 3,431,992 A | March 1969 | Whitecar |
| 3,589,459 A | June 1971 | Harvey |
| 3,990,032 A | November 1976 | Fish et al. |
| 4,033,420 | July 1977 | De Mastters |
| 4,346,771 A | August 1992 | Persson et al. |
| 4,478,091 A | October 1984 | Forrester |
| 4,638,876 A | January 1987 | Balduin et al. |
| 4,666.004 A | May 1987 | Raz |
| 4,694,921 A | September 1987 | Johnston |
| 4,899,840 A | February 1990 | Boubille |
| 5,239,137 A | August 1993 | Patzig |
| 5,417,536 A | May 1995 | Cech |
| 5,739,478 A | April 1998 | Zefira |
| 6,119,475 | September 2000 | Murrayet al. |
| 6,124,554 A | September 2000 | Muckle et al. |
| 6,148,668 | November 2000 | Sieg |
| 6,222,137 | April 2001 | Handford |
| 6,717,072 | April 2004 | Winterberg |
| 6,855,894 | February 2005 | Seumeren |
| 6,893,029 | May 2005 | Hailston |
| 7,416,378 | August 2008 | Adams |
| 7,002,083 | February 2010 | Simons |
| 7,659,484 | February 2010 | Kroll |
| 7,712,583 | May 2010 | Matsumoto |
| 10,329,037 | June 2019 | Govekar et al. |
| 10,775,226 | September 2020 | Sanhaji et al. |

### SUMMARY OF INVENTION

Often times, a mover is required to lift an object up to a shelf or a truck bed. This can be a big job for the mover, especially when the object is heavy, say more than 100 pounds and there is no one around to help. If not careful, the mover can easily sustain a back injury or encounter other injuries. Also, some mover may want to know the weight of the object being moved, such as a luggage to be transported by an airplane. Therefore, there is a need for more specially designed hand trucks.

An aspect of some embodiments of the present invention relates to a two-wheel mechanical hand truck with two additional wheels that can be unfolded to make the hand truck a four-wheel hand truck. This four-wheel hand truck has a load plate or nose plate (located in front of the two wheels) that can be moved up and down a channel track by a motor. The amount of current to run the motor will depend on the objects or loads to be placed on the nose plate and is displayed on a display (such as a liquid crystal display (LCD) or light emitting diode (LED) display, for example). The four-wheel hand truck may also include a nose plate extension for handling larger loads.

Another aspect of some embodiments of the present invention relates to a method for lifting a load and weighing the load. An electro-mechanical hand truck may be provided, and a load may be supported by the hand truck. The weight of the load is shown via the display.

### BRIEF DESCRIPTION OF DRAWINGS

FIG. 1 is a detailed view of a hand truck without a motor and an extender, according to some embodiments of the present invention;

FIG. 2A is a detailed view of a hand truck with a motor and an extender installed, according to some embodiments of the present invention;

FIG. 2B is a detail of the hand truck, showing the motor, according to some embodiments of the present invention;

FIG. 2C is a hand truck with a corded remote controller, according to some embodiments of the present invention.

FIG. 3A is a detail of a bottom section of the hand truck with nose plate lifted above the field of view of the figure, showing the motor and a controller installed, according to some embodiments of the present invention;

FIG. 3B is a close up view of an extender of the hand truck, according to some embodiments of the present invention;

FIG. 3C is a close up view of present invention with only a pulley, according to some embodiments of the present invention.

FIG. 4 is a method for measuring the weight of an object, according to some embodiments of the present invention;

FIG. 5 is a detail of the hand truck showing a latch, according to some embodiments of the present invention;

FIG. 6 is a two-wheel hand truck with a nose plate extension unfolded at the floor, according to some embodiments of the present invention;

FIG. 7 is a diagram illustrating a two-wheel hand truck with nose plate folded, and carrying a weight, according to some embodiments of the present invention;

FIG. 8 is a diagram illustrating a two-wheel hand truck with nose plate extension unfolded, carrying a weight, according to some embodiments of the present invention;

FIG. 9 is a illustrates a four-wheel hand truck in cart configuration, according to some embodiments of the present invention;

FIG. 9A illustrates a four-wheel hand truck in truck configuration, according to some embodiments of the present invention;

FIG. 10 is a detail of the four-wheel hand truck in truck configuration with holding bolts latched to the small handle, according to some embodiments of the present invention;

FIG. 11 is a illustrates a tracker bar joined to a nose plate to hold the nose plate between tracks, according to some embodiments of the present invention;

FIG. 12 is a diagram showing small rollers and their possible locations (parallel or perpendicular to the surface of the tracker bar), according to some embodiments of the present invention;

FIG. 13A shows a hand truck with a rechargeable battery and an arbor, according to some embodiments of the present invention;

FIG. 13B shows an example of the rechargeable battery, according to some embodiments of the present invention; and

FIG. 13C is a detail the two-wheel hand truck, showing an unfolded arbor, according to some embodiments of the present invention.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention, in some embodiments thereof, relates to electro-mechanical device that can be used to move objects from one location to another and to electrically lift the objects to a desired height with the object weight displayed. A device according to some embodiments of the present invention includes a two-wheel hand truck with two additional wheels that can be used as a dolly for more stability and additional accommodations. This hand truck can be used to move an object and to electrically lift the object to a desired height with the object's weight displayed, so the object can be easily transferred onto a higher platform such as a truck bed. The hand truck has a lifting platform which includes a nose plate, a nose plate extension, and an arbor. The power source may include a rechargeable battery with many functions.

Referring now to the drawings, a parts list follows indicating the numerals used to identify the different units and element in the drawings:
1. Nose Plate
2. Frame
3. Ring
4. Left Axle Bracket
5. Right Axle Bracket
6. Nose Plate Extension
7. Axle
8. Wheel (2)
9. Right Connected Plate
10. Latch
11. Left Connected Plate
12. End Cap (2)
13. Small Handle
14. Small Handle Enforcement (2)
15. Lock
16. Steel Plate
17. Handle Support Bar
18. Handle
19. Caster (2)
20. Bolt M8×30 (4)
21. Nut M8 (12)
22. Washer M16×2T (4)
23. Spacer (2)
24. Cutter Pin (2)
25. Bolt M12×100 (2)
26. Nut M12 (2)
27. Bolt M8×50 (2)
28. Bolt M8×45 (2)
29. Bolt M8×40 (2)
30. Motor
31. Mounting Plate
32. Extender
33. Pulley
34. Pulley Housing
35. Extender Mounting Hole
36. Pulley Housing Support
37. Remote Control Cable
38. Corded Remote Controller
39. Motor Power Cord
40. Motor Power Cord Connector (2)
41 Volt 900 Amp Jump Starter
42. Pulley Housing Opening
43. 6″ long 3.5″ U-bolt
44. 6″ 3″ Circular U-bolt
45. 8″ long 3″ U-bolt
46. Receiver Box
47. Breaker
48. A Hand Truck
49. Mounting Plates
50. Channel Track
51. Cordless Remote Controller
52. Microprocessor
53. Holding Bolt (2)
54. Cigarette Lighter Plug-In Adapter
55. Display Screen
56. Channel Track 1×1×1×⅛ Support
57. E1 Bracket 1×12×⅛ (2)
58. Extender Cap
59. Cable
60. Fairlead
61. Tracker Bar
62. Small Roller
63. Small Axle
64. Rechargeable Battery
65. Arbor
66. 12V-15 V IN
67. 5V 2 A OUT
68. 12V 6 A OUT
69. Housing

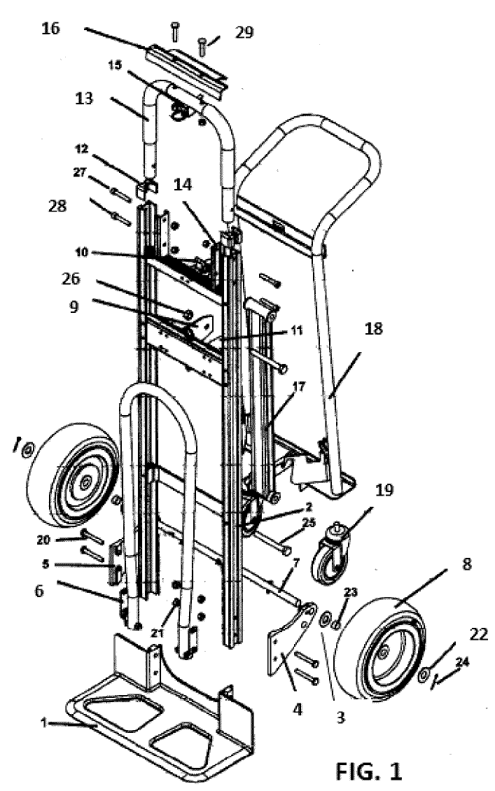

With reference to FIG. 1, an embodiment of the invention relates to a hand truck 48, which may include:
A. A Frame (2) with a Small Handle (13)
B. Two Wheels (8) and an Axle (7),
C. A Handle (18), Handle Support Bar (17) and two Castors (19),
D. A Nose Plate (1) and Nose Plate Extension (6) with their supporting parts (3-5, 9-12, 14-16, 20-29).

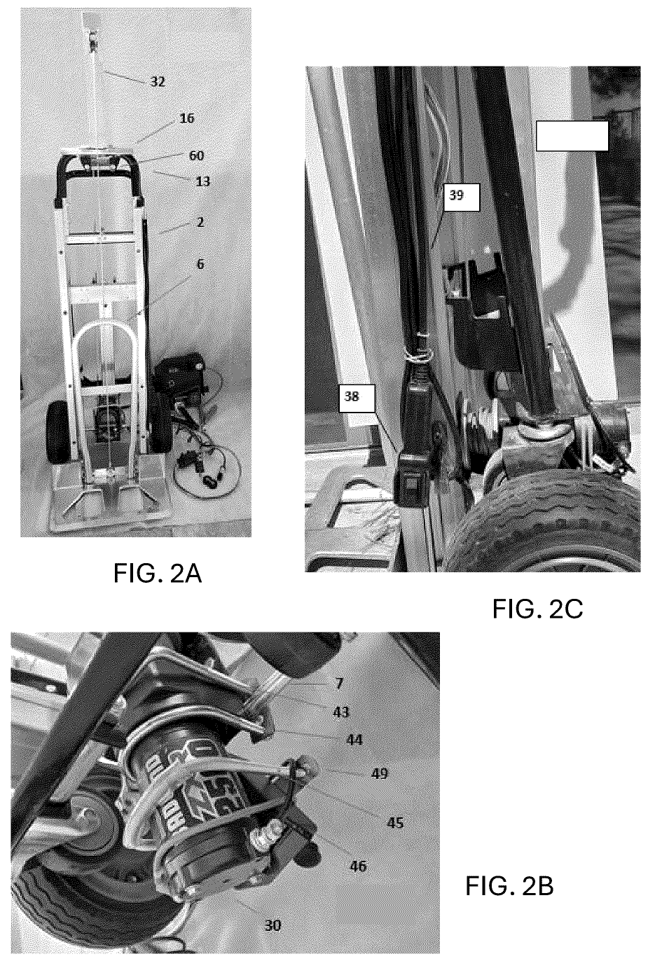

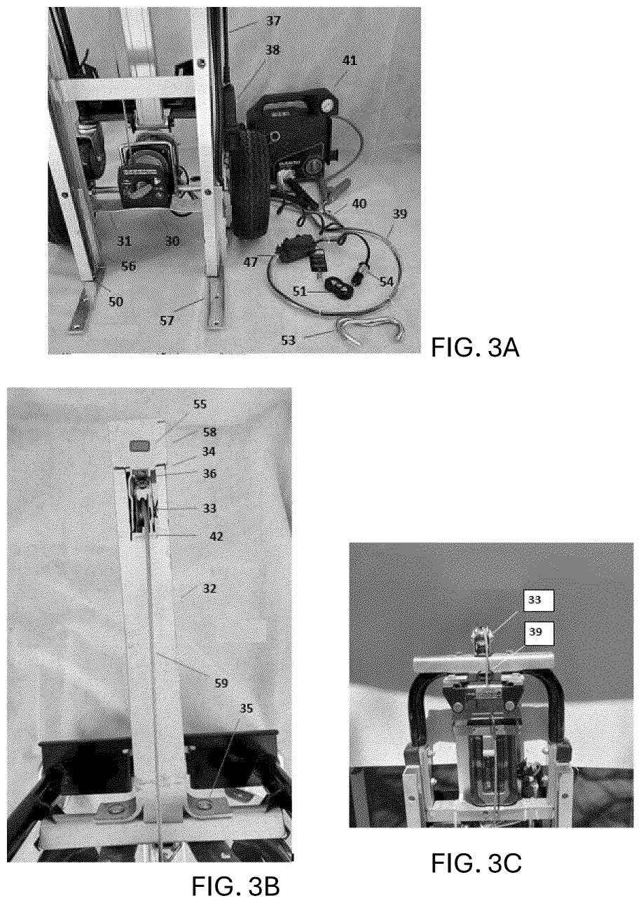

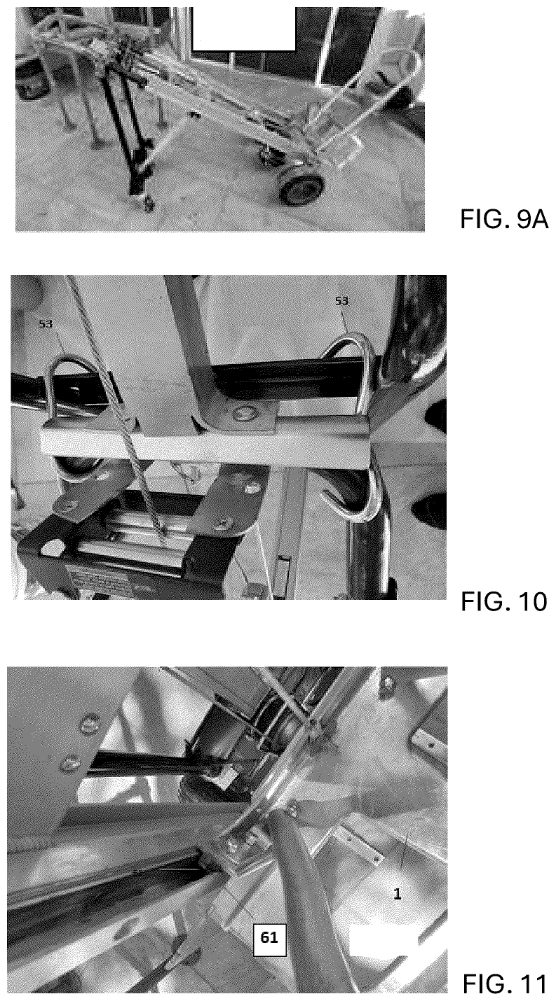

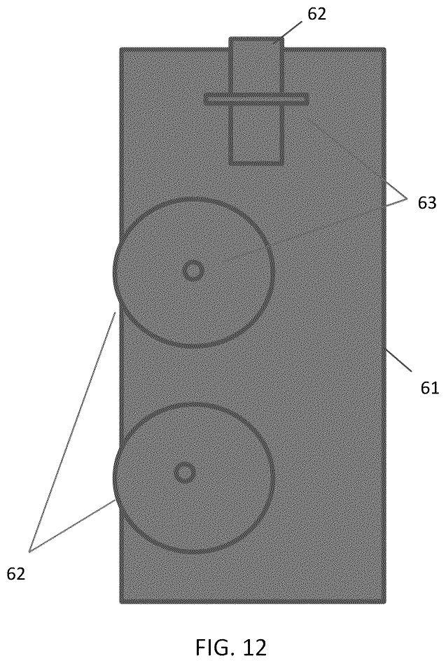

FIG. 2 shows an assembled hand truck with a Motor (30) and an Extender (32) attached. The Motor (30) may be mounted on a Plate (31) (FIG. 3A), which is attached to Axle Plates (4, 5) with two bolts. A rear view of Motor (30) is shown in FIG. 2B, showing the motor also attached to Axle (7) with a 6″ long 3.5″ U-bolt (43) and a 6″ long 3″ circular U-bolt (44) via two brackets. The Receiver Box (46) of Motor (30) is attached to Motor (30) via Mounting Plates (49). The Extender (32) is used to extend the height of Hand Truck (48) to a desired level, for example 60 inches (or 5 feet). The Extender (32) is also used for securing a Pulley (33) position as shown in FIG. 3B. Pulley (33) is secured by Pulley Housing (34) to be located in Pulley Housing Opening (42). Extender (32) is capped off with Extender Cap (58) and is secured to the top of Steel Plate (16) (FIG. 2A) by Holes (35) at the base of the Extender (32) (FIG. 3B). A Display (55) may be located in the Extender Cap (58) as shown in FIG. 3B. Motor (30) is used to move Nose Plate (1) and Nose Plate Extension (6) up and down Channel Track (50) via a Cable (59) using either a Corded Remote Controller (38) or a Cordless Remote Controller (51). The Nose Plate (1) is held in tracks by two Tracker Bars (61) as shown in FIG. 11. These Tracker Bars (61) can be fitted by one or more small rollers (in parallel as well as perpendicular to the surface of the tracker bar) as shown in FIG. 12. The Corded Remote Controller (38) (FIG. 3C) is connected to Motor (30) via Motor Power Cord (39). Motor (30) receives its power from a 12-volt 900 Amp Jump Starter (41) or via a Cigarette Lighter Plug-In Adapter (54). In some embodiments of the present invention, Motor Power Cord (39) is protected from electrical shock via a powerful Breaker (47), as shown in FIG. 3A. FIG. 6 illustrates a hand truck with Nose Plate Extension (6) unfolded at the floor. FIG. 8 demonstrates a load on Nose Plate Extension (6) at a height (about 3 feet from the ground). FIG. 3A also shows El-Brackets (52) supporting Hand Truck (48) at the foot of Frame (2). In some embodiments, an extender may simply be a mounting holder of a pulley, as illustrated in FIG. 2C and FIG. 9A.

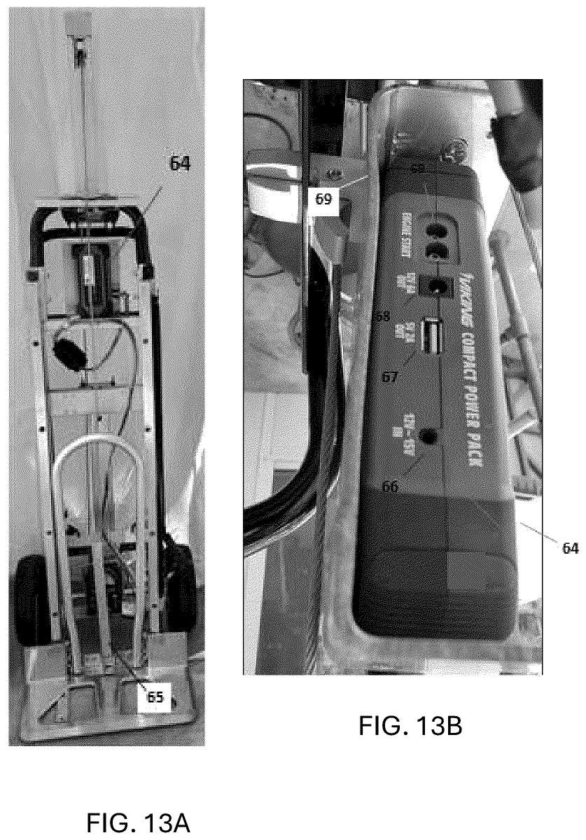

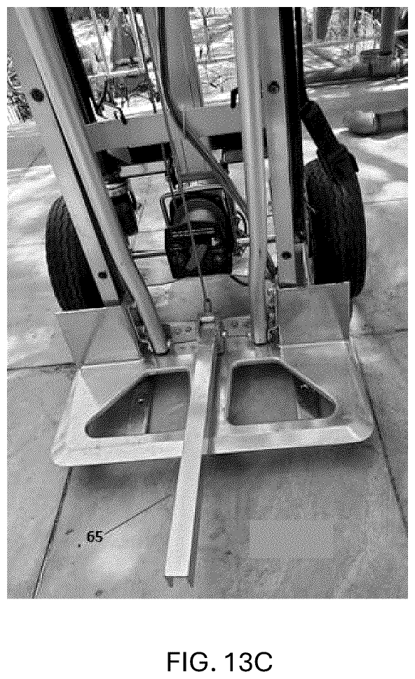

FIG. 13A illustrates another embodiment of this electric hand truck. The embodiment shows a Rechargeable Battery (64) located in a Housing (69) and an Arbor (65) located in the mid portion of the Nose Plate (6). FIG. 13B shows the inputs and outputs to the Rechargeable Battery (64). The 12V-15V IN (66) is a charging input socket. The 5V 2 A OUT (67) is USB output port for USB devices such as a lap-top computer. The 12V 6 A OUT (68) is a 12 VDC output port for a 12 VDC device such as a portable fan. The Engine Start Socket is for use to run the Electric Hand Truck (48).

This rechargeable battery has the following features:
1. Battery to power the electric hand truck 2. An LED flashlight 3. SOS signaler 4. A 5V 2 A USB output port 5. A 12V 6 A output port and 6. an engine starter.

There are seven possible operating positions for the hand truck.

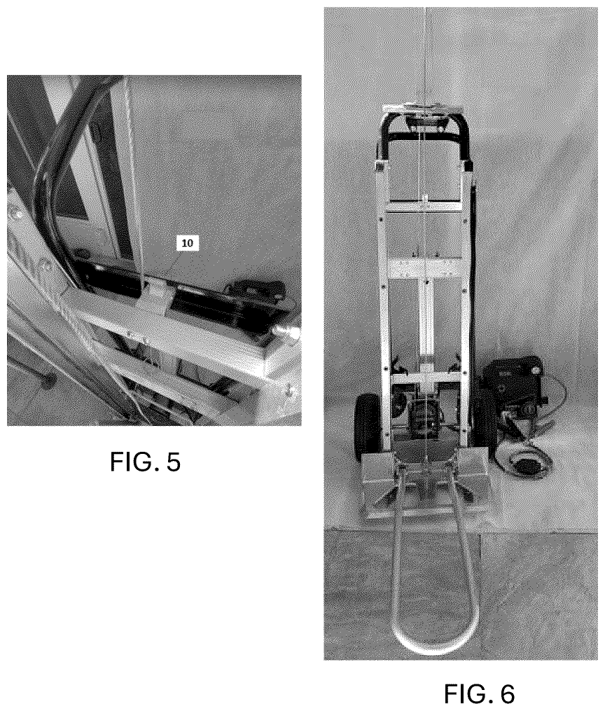

1. Two-Wheel Hand Truck Position
a. Stand both Frame (2) and Handle (18) upright as shown in FIG. 2A.
b. Handle (18) should be latched to Frame (2) by Latch (10) (FIG. 5).
c. Both hooks at bottom of Handle (18) (FIG. 1) should be engaged to Frame (2).

2. Two-Wheel Assisted Hand Truck Position

With Hand Truck in upright position, unfold Nose Plate Extension (6) so that it rests horizontally on Nose Plate (1) as shown in FIG. 6.

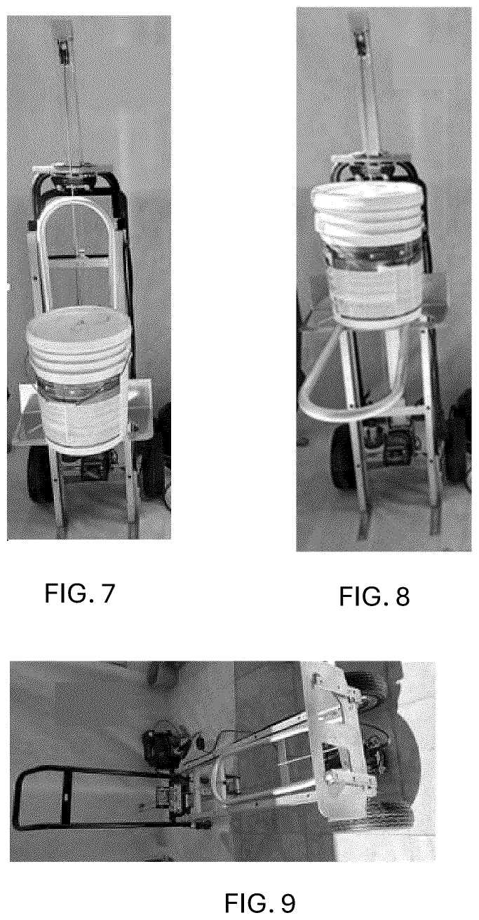

3. Two-Wheel Hand Truck Position with a Load on Nose Plate (1) at a desired height with its weight displayed as shown in FIG. 7.

4. Two-Wheel Hand Truck Position with a Load on Nose Plate Extension (6) at a desired height with its weight displayed as shown in FIG. 8.

5. Four-Wheel Cart Position
a. Detach Handle (18) from Frame (2) by unlatching Latch (10) as shown in FIG. 5 and then pulling Handle (18) down until Extender (32) moves pass Handle (18).
b. Lower Frame (2) until the Small Handle (13) sits in the groove at the bottom of Handle (18) as shown in FIG. 9.

6. Four-Wheel Hand Truck Position
a. Detach Handle (18) from Frame (2) by unlatching Latch (10) as shown in FIG. 5 and then pulling Handle (18) down until Frame (2) leans against the Handle (18) as shown in FIG. 9A.
b. Latch the Holding Bolts (53) to the Small Handle (13) as shown in FIG. 10.

7. Two-Wheel Hand Truck Position with an unfolded arbor as shown in FIG. 13C. The arbor is a shaft that is used to lift objects with a hole in the middle, such as a roll of electrical wire, paper for newspaper, metal sheeting, aluminum foil, etc. These objects are often difficult to lift in any other way. The arbor traverses the object via the hole in the object and supports the object by contact with an internal surface of the object or a roller the object is rolled on.

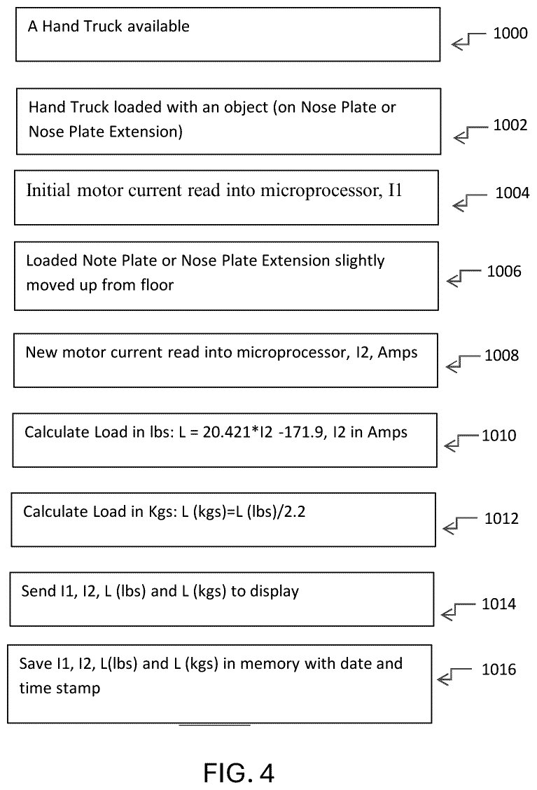

In a method according to the invention, the weight of the load being carried by a hand truck may be calculated and displayed as outlined in FIG. 4:

In this figure, a hand truck is provided at 1000. At 1002, the hand truck may have an object on its Nose Plate (1) as shown in FIG. 6 or on Nose Plate Extension (6) as shown in FIG. 4. At 1004, an initial motor current, I1, in Amps is read into a Microprocessor (52). At 1006, the loaded Nose Plate (1) or Nose Plate Extension (6) is slightly elevated from the floor. At 1008, the new motor current, I2 in Amps, is read into Microprocessor (52) At 1010, the weight of the object is calculated in lbs according to the formula Weight (lbs.)=20.421*I2 (Amps)+171.9, which is fitted from data given in TABLE 1 for a motor with a 5% or less possible error. At 1012 weight in kilograms may be calculated by converting pounds to kilograms according to known conversion multipliers. At 1014, current and weight data is sent to a display screen (55). At 1016, current and weight information with date and time are stored in a digital memory utility.

TABLE 1

| Load | Current |
|---|---|
| (lbs.) | (Amps) |
| 0 | 10 |
| 1000 | 55 |
| 2000 | 106 |
| 2500 | 132 |

Although the invention is described above in terms of various exemplary embodiments and implementations, it should be understood that the various features, aspects, time measurements, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

1. A hand truck and method for using the hand truck, as described in the specification and shown in the drawings.

2. A hand truck comprising: a frame with an axle, 2 wheels, and a small handle; a nose plate, a nose plate extension, and an arbor; and a handle with a handle support bar, two casters.

3. The hand truck of claim 2, further comprising a motor with two connecters for connecting to a 12-volt battery.

4. The hand truck of claim 3, further comprising a wired remote control.

5. The hand truck of claim 4, further comprising a wireless remote control.

6. The hand truck of claim 2, further comprising a wireless remote control.

7. The hand truck of claim 3, further comprising a cigarette lighter plug-in adaptor.

8. The hand truck of claim 3, further comprising a microprocessor and a display.

9. The hand truck of claim 4, further comprising a microprocessor and a display.

10. The hand truck of claim 5, further comprising a microprocessor and a display.

11. The hand truck of claim 6, further comprising a microprocessor and a display.

12. The hand truck of claim 7, further comprising a microprocessor and a display.

13. The hand truck of claim 2, further comprising a spring or a counter weight for helping to pull down the nose plate on descending.

14. The hand truck of claim 2, further comprising a nose plate with the side trackers installed with one or more small rollers for helping to guide the up down movement of the nose plate. The rollers can be in either parallel or perpendicular or both to the tracker bar.

15. The hand truck of claim 14, further comprising a spring or a counter weight for helping to pull down the nose plate on descending.

16. The hand truck of claims 4-12, further comprising a spring or a counter weight for helping to pull the nose plate on descending.

17. The hand truck of claims 4-12, further comprising a nose plate with the side trackers installed with one or more small rollers for helping to guide the up down movement of the note plate.

18. The hand truck of claim 17, further comprising a spring or a counter weight for helping to pull down the nose plate on descending.

19. The hand truck of claim 16 with the 12-Volt battery being a rechargeable battery.

20. The hand truck of claim 19 with the rechargeable battery having the following additional functions: a flashlight, an SOS light, a 12 V 2 A USB port, and a 12 V 6 A port.

21. The hand truck of claim 17, further comprising a nose plate with the side trackers installed with one or more small rollers for helping to guide the up down movement of the note plate.

22. The hand truck of claim 21, further comprising a spring or a counter weight for helping to pull down the nose plate on descending.

23. The hand truck of claim 18, further comprising a nose plate with the side trackers installed with one or more small rollers for helping to guide the up down movement of the note plate.

24. The hand truck of claim 23, further comprising a spring or a counter weight for helping to pull down the nose plate on descending.

25. A method of weighing, comprising:
providing a hand truck as described in claims 1-12 above;
connecting the hand truck to an electrical source;
reading current from the motor circuit into a microprocessor, I1, in Amps;
placing a load on the hand truck, either on the nose plate or nose plate extension;
moving the load up slightly or to a desired position;
reading current from the motor circuit into a microprocessor, I2, in Amps;
calculating weight (lbs.) from weight (lbs.)=function (I2);
calculating weight (kgs.) by dividing weight (lbs.) by 2.2;
sending values of I1, I2, weight (lbs.), weight (kgs.) to display; and
storing I1, I2, weight (lbs.), weight (kgs.) with date and time to a digital memory.
